(19) United States
(12) Patent Application Publication
(10) Pub. No.: US 2015/0166930 A1
(43) Pub. Date: Jun. 18, 2015

(54) REDUCTION OF MCPD-COMPOUNDS IN REFINED PLANT OIL FOR FOOD

(71) Applicant: AAK AB, Malmö (SE)

(72) Inventors: Krister Hed, Karlshamn (SE); Martin Johansson, Morrum (SE); Jens Mellerup, Tilst (DK)

(21) Appl. No.: 14/415,235

(22) PCT Filed: Jun. 27, 2013
(86) PCT No.: PCT/EP2013/063506

§ 371 Date: Jan. 16, 2015

(30) Foreign Application Priority Data
Jul. 18, 2012 (DK) PCT/DK2012/050271

(51) Int. Cl. C11B 3/00; A23D 9/00

(52) U.S. Cl. CPC C11B 3/001; A23D 9/00

(57) ABSTRACT

The present invention provides a process for lowering the amount of esters of 2- and 3-MCPD in refined triglyceride oil, wherein said oil prior to entering the process has been treated with one or more refining steps and wherein said oil comprises triglycerides of fatty acids having a carbon chain length of C12-C24 in an amount of at least 50% of the total triglyceride content, the process comprising the steps of: blending the oil with a base and heat treating the oil while passing steam through the oil at reduced pressure, keeping the degree of interesterification in the product from the process below 60%.

### FIELD OF THE INVENTION

The present invention relates to the field of edible triglyceride oils. In particular, the invention relates to a method for reducing the amount of 3-chloro-1,2-propanediol and related compounds in triglyceride oils.

### BACKGROUND OF THE INVENTION

It is known that 3-chloro-1,2-propanediol (3-MCPD) and 2-chloro-1,2-propanediol (2-MCPD) are formed in processed fats for foodstuff. Typically, these compounds are found as esters of fatty acids in triglyceride fats and oils at various concentrations, depending on the oil source, refining steps and other factors.

Also, glycidol and fatty acid esters thereof may be present in refined triglyceride fats and oils.

MCPD-compounds and glycidol-compounds are not desirable in foodstuff due to potential hazards related to their intake. Knowledge about the exact mechanisms of the formation of MCPD-compounds during the processing of edible oils is limited. There remains a need to reduce the concentrations of the mentioned compounds in triglyceride oils for foodstuff.

### SUMMARY OF THE INVENTION

The present invention pertains to a process for lowering the amount of esters of 2- and 3-MCPD in refined triglyceride oil, wherein said oil prior to entering the process has been treated with one or more refining steps and

wherein said oil comprises triglycerides of fatty acids having a carbon chain length of C12-C24 in an amount of at least 50% of the total triglyceride content,

the process comprising the steps of:
blending the oil with a base and
heat treating the oil while passing steam through the oil at reduced pressure,

keeping the degree of interesterification in the product from the process below 60%.

It has surprisingly been found that a lowering of the amount of MCPD-compounds in triglyceride oils comprising triglycerides of fatty acids having a carbon chain length of C12-C24 in an amount of at least 50% of the total triglyceride content,

can be achieved by a treatment with aqueous base and a heat treatment at reduced pressure with steam-stripping and, at the same time, keeping the degree of interesterification below 60 % so that the triglyceride structure affecting the physical and/or nutritional properties of the native oil is not altered too much.

The degree of interesterification is defined herein as follows:

For a fat with considerable change in physical properties due to interesterification, such as palm oil, the degree of interesterification is most conveniently measured as the change in the solid fat content (SFC) of the product compared to the SFC of the starting oil (0% interesterification) and the SFC of a fully randomized (chemical interesterified with sodium methoxide) starting oil (100% interesterification). The degree of interesterification is defined as the percentage change SFC in a sample relative to the SFC in the starting oil and the fully randomized oil.

Solid fat content was measured at 10, 20, 30 and 35° C. according to IUPAC 2.150(a), the degree of interesterification was calculated as the average result from the measurements at the 4 temperatures. When other oils like palm mid fraction or shea stearin is subject to the process, solid fat content should be measured by IUPAC 2.150 b due to the polymorphic nature of these fats, as other temperature may be relevant for other fats.

For liquid oil like sunflower oil the SFC is not suitable for determining the degree of interesterification. Instead the fatty acid composition in the sn-2 position of the triglyceride according to IUPAC 2.210 was used to calculate the degree of interesterification. The starting oil was defined as 0% interesterified. 100% interesterification was defined as to correspond to a sn-2 fatty acid composition being equal to the total fatty acid composition (measured with IUPAC 2.304).

It is quite surprising that the inventive process succeeds in efficiently lowering the amount of MCPD-compounds in a process comprising blending the oil with base at elevated temperatures without causing excessive interesterification, since base is known to catalyze interesterification in triglyceride oils.

Particularly for longer chain fatty acid triglycerides the degree of interesterification is to be kept below 60% according to the inventive process particularly to preserve the triglyceride structure of the original oil and thereby obtaining a somewhat predictable product from the process with respect to for example melting point.

In an embodiment of the invention the degree of interesterification in the oil is 50% or less or 40% or less, preferably 30% or less, more preferably 20% or less, most preferably 10% or less.

According to embodiments of the present invention, the degree of interesterification in the triglyceride oil is preferably kept as low as possible. In certain embodiments of the present invention, surprisingly low degrees of interesterification may be achieved.

In an embodiment of the invention the heat treatment is performed at a temperature between 120° C. and 240° C., preferably between 175° C. and 235° C. most preferably between 200° C. and 225° C. In further advantageous embodiments of the invention, the heat treatment is performed at temperatures such as 140° C. to 235° C. or 160° C. to 230° C., in particular temperatures between 170° C. and 225° C., 180° C. to 220° C. or 190° C. to 215° C.

The heat treatment of the inventive process is preferably carried out at mild conditions, for example at temperatures not too high. By keeping the temperature comparatively low, a more selective process may be achieved, wherein the MCPD-esters in the oil are reacting with aqueous base at the position of the chlorine atom to a higher extent than reacting at the glyceride ester-bonds. The selection of the process temperature or range of temperatures depends on, for example, the oil composition and also the concentration of base and other factors.

In an embodiment of the invention the heat treatment has a duration of between 10minutes and 4 hours, preferably between 20 minutes and 3 hours, more preferably between 30 minutes and 2 hours. In further advantageous embodiments of the invention, the duration of the heat treatment is between 25 minutes and 2.5 hours, for example between 40 minutes and 2.1 hours or 1 hour and 1.7 hours.

The time for running the heat treatment of the inventive process may vary, depending for example on the specific oil composition, including the concentration of MCPD-compounds in the oil.

In an embodiment of the invention the reduced pressure is between 1 and 100 mbar, preferably between 1.5 and 30 mbar, more preferably between 2 and 10 mbar.

The heat treatment of the inventive method is run at reduced pressure. One advantage of this is to avoid oxidative decomposition during the process—and another is that glycidol fatty acid esters formed by the heat treatment are evaporated. Yet another advantage is that it is also believed that some of the undesired MCPD-compounds and certain more volatile reaction products are more easily stripped of the blend, whereby a more effective process may be achieved. A complex relationship exists between the reduced pressure used in the process, partial pressures of different oil components, process time and other process variables.

In an embodiment of the invention the process further comprises the step of, subsequently to the heat treatment, removing the soap formed in the oil by adding base, by contacting the oil with neutral bleaching earth.

It has surprisingly been found that in order to maintain a low level of MCPD-compounds when removing the soap residues from the oil it is important to use neutral bleaching earth for this soap removal process.

If acids are used to remove the soap or if acid bleaching earth is used, MCPD-compounds may be formed either during the bleaching process or during a following deodorization, and the effect of the inventive process may be diminished in that amount of MCPD-compounds in the oil may be going up contrary to the intention of using the inventive process. However, the added base may neutralize a small addition of acid bleaching earth thus creating neutralized bleaching earth in situ.

In an embodiment of the invention the bleaching earth is selected from the group consisting of bleaching clays based on mineral and bleaching earth with a pH in hydrous suspension between 4 and 9.

In a subsequent bleaching process using bleaching clays, the pH of the used clays in hydrous suspension may preferably be within a pH range comparatively close to neutral. For example preferred ranges for the pH include a pH from 5-8.5 such as 6-8.

In an embodiment of the invention the clays based on mineral are selected from the group consisting of bentonit, fuller earth and sepiolite.

A wide range of mineral clays and other commercial bleaching products may be used for subsequent removal of soap residues and other impurities like glycidyl esters as long as they are not too acidic or used in combination with acids.

In an embodiment of the invention the concentration of glycidyl esters in the triglyceride oil is reduced by at least 80%, preferably at least 90% when compared to the concentration of glycidyl esters in the triglyceride oil after the heat treatment, by contacting the oil with neutral bleaching earth or by contacting the oil with neutral bleaching earth followed by a deodorization.

Glycidyl esters are, alongside with MCPD-compounds, not desirable in edible oils. The inventive process, in preferred embodiments, may help diminishing the amount of glycidyl esters. Further, already the alkali heat treatment lowers the glycidyl ester content if the content in the starting oil is high, which is the case if starting with an oil that has been refined at a high temperature such as a physical refined RBD palm oil. In a physically refined RBD palm oil, the glycidyl ester content is often high and an alkali heat treatment as described herein decreases not only the MCPD but also glycidol compounds.

Analysis of glycidyl-esters may be performed by different methods. As used herein, “glycidol” refers to sum of glycidol and their respective esters reported as equivalents of their free form. This may be done e.g. with methods using a alkaline ester cleavage followed by e.g.. GC-MS detection of glycidol after derivatization. The values given are then a sum of glycidol and their respective esters as equivalents of their free form. One method is DGF C-VI 18 (10) where glycidyl esters are analyzed and reported as equivalents of glycidol. Another method is SGS “3-in-1” (Kuhlmann, Eur. J. Lipid Sci. Technol. 2011, 113, 335-344).

Similarly, analysis for 2-MCPD-esters, 3-MCPD-esters may be performed using “3-in-1” method which employs mild alkaline ester cleavage followed by GC-MS detection of 3-MCPD, 2-MCPD (and glycidol, supra). The values given are then a sum of each of 3-MCPD, 2-MCPD as well as glycidol and their respective esters reported as equivalents of their free form.

In an embodiment of the invention the one or more refining steps before the heat treatment are selected from the group consisting of

de-gumming, washing, drying, neutralizing, bleaching, carbon treatment, filtering, distillation and deodorisation.

The MCPD-compounds to be reduced in the triglyceride oil according to the inventive process are believed to be formed in the oil from components present in the oil during the refining process.

As such, the present process is particularly relevant for refined oils.

In an embodiment of the invention, free fatty acids are added to the oil.

The addition of free fatty acids to the oil may result in some benefits, for example by suppressing the degree of interesterification.

In an embodiment of the invention free fatty acids are added to the oil prior to and/or during heat treatment.

The addition of free fatty acids to the oil prior to and/or during the heat treatment in some embodiments of the invention may result in some benefits, for example by suppressing the degree of interesterification.

In embodiments of the invention, where very low degrees of transesterification are desired, free fatty acids may be added to the reaction mixture. Particularly longer chain, i.e. ≧C20, free fatty acids such as behenic or erucic fatty acids are beneficial due to their lower rate of evaporation. Since the longer chain fatty acids have a lower rate of evaporation, a lower amount of free fatty acids may be added and still get a low degree of interesterification which is also beneficial. Examples of free fatty acids with ≧C20 are arachidic, behenic, lignoceric, gondoic, erucic, nervonic, arachidonic, eicosapentaenoic acid (EPA) and docosahexaenoic acid (DHA).

In an embodiment of the invention the free fatty acid are added in an amount of 0.1-3%, such as 0.1, 0.2, 0.3, 0.4, 0.5, 0.6, 0.7, 0.8, 0.9, 1, 1.5, 2, 2.5 or even 3%, by weight of the amount of oil before and/or during the heat treatment. Said free fatty acids may be added in a continuous way, during the process starting at time point 0, i.e. before the process starts, and then continuously during the heat treatment to keep the free fatty acid levels about constant at levels exemplified above, i.e. in an amount of 0.1-3%. Said fee fatty acids may also be added in a continuous way starting anytime during the heat treatment process. Said free fatty acids may further be added in a repeated way before and during the process starting at time point 0, which is before heat treatment, as well as repeatedly during heat treatment such as every 5,10, 15, 20, 25, 30, 35, 40, 45, 50, 55, or even every 60 minute in a fixed amount, such as listed herein (supra and in Examples). When adding the free fatty acids repeatedly, they may as well be added repeatedly starting anytime during the heat treatment process. Said free fatty acids may further be added continuously or repeatedly before and/or during the heat treatment in fixed or in non-fixed amounts to allow for a high degree of flexibility of free fatty acid levels during the heat treatment.

In an embodiment of the invention glycerol is added to the oil prior to heat treatment. Experiments have shown that the addition of glycerol to the reaction mixture of triglyceride oil and aqueous base may decrease the needed concentration of base and thereby suppress the measured degree of interesterification while the reduction in the amount of MCPD-compounds is not significantly affected.

In embodiments of the invention, where very low degrees of transesterification are desired, glycerol may be added to the reaction mixture.

In an embodiment of the invention the glycerol is added in an amount of 0.1 to 1% by weight of the amount of oil.

In an embodiment of the invention the oil comprises triglycerides of fatty acids having a carbon chain length of C12-C24 in an amount of at least 60% of the total triglyceride content, preferably at least 75%, more preferably at least 85% of the total triglyceride content.

In preferred embodiments of the present invention the triglyceride oil comprises large amounts of long-chained fatty acid esters. For these oils it may be particularly important to control the degree of interesterification taking place to a certain extend when applying the inventive process.

Excessive interesterification may lead to less valuable oils due to alteration of the physical and/or nutritional properties of the original oil.

Therefore, the inventive process is particularly useful when treating triglyceride oils comprising large amounts of long chain fatty acid esters, when preservation of a particular triglyceride composition is desirable.

In an embodiment of the invention the triglyceride oil is obtained from palm oil, sunflower oil, rape seed oil, soy bean oil, corn oil, coconut oil, palm kernel oil, shea kernel oil, structured triglycerides manufactured by positional specific lipases, their fractions and combinations thereof.

A number of natural triglyceride oils have a composition suitable for use in the presently disclosed process.

In an embodiment of the invention the base is selected from the group consisting of NaOH, KOH, and other hydroxides of alkali metals or alkaline earth metals.

According to embodiments of the present invention hydroxides are preferred as bases. Other bases may be used.

In an embodiment of the invention the base is provided as an aqueous solution, a solid, saponified fatty acids, saponified triglyceride oil or any combination thereof. In order to achieve the desired results, small amounts of water may be needed to assist in the base-catalyzed reactions taking place in the triglyceride oil. Most oils comprise small amounts of water and the base may be added as a solid and still efficiently act as a hydrous base when contacting the water in the oil. Water is also present in the form of steam which is passed through the oil. Nevertheless, it may be convenient to add the base as an aqueous solution in some embodiments.

In an embodiment of the invention the concentration of base blended into the oil corresponds to 2 ppm-30 ppm hydroxide ion, preferably between 3 ppm and 20 ppm hydroxide ion more preferably between 4 ppm to 15 ppm hydroxide ion, most preferably between 5 ppm to 12 ppm hydroxide ion.

In preferred embodiments of the present invention, the base concentration is kept within certain limits, for example between 6 ppm and 10 ppm hydroxide ion. This may help in controlling the degree of interesterification while still effectively aid in the removal of MCPD-compounds.

In an embodiment of the invention the concentration of esters of 2- and 3-MCPD in refined triglyceride oil is reduced by at least 50%, preferably 60 % more preferably 70%, most preferably at least 80% relative to the initial concentration.

In preferred embodiments of the present invention, at least half of the MCPD-compounds are removed from the oil.

To meet demand for oil with low MCPD-concentrations, for example for applications involving baby food, it may be necessary to substantially reduce the amount of MCPD-compounds in the oil. According to preferred embodiments of the present invention, such substantial reductions may be achieved. It has to be kept in mind, however, that even less drastic reductions of the concentration of MCPD-compounds in the oil may be useful.

In an embodiment of the invention the triglyceride oil has a native triglyceride structure. In preferred embodiments of the present invention, the triglyceride oil treated according to embodiments of the invention has a native or non-randomized triglyceride structure. For example, the oil may have been subjected to a fractionation process, but not otherwise significantly altered with respect to triglyceride structure.

In order to preserve both nutritional and physical properties of native oil, it may be highly desirable to avoid alteration of the non-randomized triglyceride structure prior to heat treating with base.

The present invention also pertains to a triglyceride oil treated according to the process of claim 1.

The present invention further pertains to the use of triglyceride oil treated according to the process of claim 1 in food applications.

### DETAILED DESCRIPTION

The process of the present invention is reducing the amount or MCPD-compounds in refined triglyceride oils without randomizing the triglyceride structure of the oil to a too high extent. This is particularly important if the physical and nutritional properties of the natural oil feedstock are to be retained.

The heat treatment of the refined triglyceride oil with aqueous base somewhat selectively reduces the amount of MCPD-compounds without leading to complete interesterification of the oil. It is believed that base catalyzed reactions at the chlorine atom in MCPD-compounds, whereby the net reaction is that chloride may be exchanged with hydroxide, removes the halogen in a volatile form due to the simultaneous stripping with steam at reduced pressure. The exact reactions and mechanisms involved are not entirely clear.

The process parameters may advantageously be chosen to optimize both the lowering of MCPD-compound concentration in the oil and the desired suppression of interesterification processes in the oil.

Important parameters are for example the concentration of base, the process temperature, the pressure during heat treatment, process time, the content of free fatty acids in the triglyceride oil and the content of glycerol and free OH-groups in mono- and diglycerides. Many of these parameters may be interrelated in a more or less complicated manner.

The concentration of base is important for the desired removal of MCPD-compounds and the undesired interesterification since both are catalysed by base.

It is advantageous to keep the concentration of base comparatively low in order to avoid extensive interesterification of the triglyceride oil. Interesterification may lead to oil with for example melting properties considerably different from the original oil or with lower bioavailability of essential fatty acids. To preserve the original triglyceride composition as much as possible it may be advantageous to keep the concentration of base comparatively low. On the other hand, if base concentration is too low, the process of removing MCPD-compounds may become inefficient. The choice of concentration of base is thus based on a trade-off between desired and undesired reactions, and, for example, the choice of process temperature. If a particular degree of interesterification is chosen as the tolerable maximum, lowering the base concentration may allow for a higher process temperature.

Process temperature during the heat treatment of the refined triglyceride oil with base again affects both the efficiency with which MCPD-compounds are removed and the degree of interesterification. Other parameters being the same, the higher the temperature, the more interesterification may take place. Experiments show that for other parameters fixed, there may exist an optimum temperature in relation to lowering the concentration of MCPD-compounds in the oil. Again, a trade-off has to be made to avoid too much interesterification.

The pressure during the heat treatment also influences both the degree of interesterification and removal of MCPD-compounds, for example by controlling the content of free fatty acids which is believed to decrease rate of the interesterification process or by increasing the evaporation of undesired substances.

Process time or the time used for the heat treatment also influences both the degree of interesterification and removal of MCPD-compounds. Depending on what is most important and other parameters fixed, the process time may be chosen to be relatively short, for example 45 minutes, to remove a large part of the MCPD-compounds and still keeping degree of interesterification at a lower level, or a longer process time, for example 80 minutes, may be chosen to remove even more MCPD-compounds, but at the expense of a higher degree of interesterification.

The concentration of free fatty acids (FFA) in the triglyceride oil during the heat treatment with base also affects the degree of interesterification. It may be advantageous to add FFA to the oil-base mixture. This may be done before and/or during heat treatment as described herein or to adjust the previous refining process to have a higher than normal content of free fatty acids, because experiments have shown that interesterification may be suppressed to a certain extend without significantly affecting the efficiency of the lowering of MCPD-compound concentrations. Actually experiments indicate that the removal of glycidyl-compounds may also be more efficient when the FFA-concentration in the triglyceride oil entering the heat treatment with base is comparatively high.

Similar effects may also be seen if glycerol is added the triglyceride oil prior to heat treatment with base: Decrease of base addition but still good efficiency of lowering the MCPD-compound concentrations may be obtained.

In an advantageous embodiment of the present invention, the heat treated triglyceride oil is subsequently treated with neutral bleaching earth to remove small amounts of soap that have been formed during the treatment with base. It has been found that alternative methods for soap removal, such as the addition of acids, may actually result in the formation of MCPD-compounds, thereby counteracting the main purpose of the inventive process. A bleaching process with neutral bleaching earth may also effectively reduce the amount of glycidyl esters in the oil. Acidic bleaching earth or bleaching earth activated with acid may also remove glycidyl esters but may tend to aid in the formation of MCPD-compounds if used in higher amounts than what the added base is able to neutralise.

Use of neutral bleaching earth has been found to preserve the low concentrations of MCPD-compounds and at the same time effectively removing soap residues and glycidyl esters.

It is generally important that further processing of the oil after the inventive alkaline heat treatment does not elevate the amount of MCPD-compounds in the triglyceride oil significantly.

### EXAMPLES

### Example 1: Heat Treatment of Oil

600 g of refined palm oil olein with an iodine value of 56 (RBD POO IV56) was mixed with 0.11 ml 4 M aqueous NaOH, corresponding to 13 ppm OH⁻. The blend was heated to 215° C. for 2 hours in a glass laboratory deodorizer at a reduced pressure of about 2 mbar. About 2 weight % steam was used as stirring and stripping agent.

TABLE 1
Effect of heat treatment with aqueous base and steam at
215° C. and 2 mbar on selected oil constituents

| | Before heat treatment | After heat treatment |
|---|---|---|
| [3-MCPD] | 3.3 ppm | 0.7 ppm |
| [2-MCPD] | 1.6 ppm | 0.4 ppm |
| Degree of interesterification | — | 45% |
| Glycidol | 8.4 ppm | 5.3 ppm |

As can be seen from Table 1, the concentration of MCPD-compounds in the oil is reduced by about 78% from a total of 4.9 ppm to a total of 1.1 ppm.

It is also evident from Table 1 that the concentration of glycidol compounds is reduced after the heat treatment.

In this experiment, considerable interesterification occurred (45%).

Analysis for 2-MCPD-esters, 3-MCPD-esters and glycidyl-esters was performed by the external contract laboratory of SGS, Hamburg, Germany using their “3-in-1” method which employs mild alkaline ester cleavage followed by GC-MS detection of 3-MCPD, 2-MCPD and glycidol. The values given are a sum of each of 3-MCPD, 2-MCPD and glycidol and their respective esters reported as equivalents of their free form.

The degree of interesterification was assessed by comparing the solid fat content (SFC) of the product with the SFC the starting oil (0% interesterification) and the SFC of a fully randomized (chemical interesterified with sodium methoxide) starting oil (100%) interesterification). Solid fat content was measured at 10, 20, 30 and 35° C. according to IUPAC 2.150(a), the degree on interesterification is calculated as the average result of the 4 temperatures. Given the measurement accuracy of SFC measurement the estimated error of the degree of interesterification is approximately 5 to 10 units.

### Example 2: Effect of Pressure

The experiment from Example 1 was repeated, but the pressure was reduced to about 10 mbar and 30 mbar instead of 2 mbar.

TABLE 2
Effect of heat treatment with aqueous base and steam at 215° C.
and 10 mbar/30 mbar on selected oil constituents.

| | | After heat treatment | |
|---|---|---|---|
| Pressure | Before heat treatment | 10 mbar | 30 mbar |
| [3-MCPD] | 3.3 ppm | 1.2 ppm | 1.3 pm |
| [2-MCPD] | 1.6 ppm | 0.7 ppm | 0.8 ppm |
| Degree of interesterification | — | <5% | <5% |
| Glycidol | 8.4 ppm | 5.9 ppm | 5.8 ppm |

The results in Table 2 show that the concentration of MCPD-compounds is still effectively diminished by over 60% while the degree of interesterification is drastically reduced when compared to Example 1 to less than 5 %.

The concentration of glycidol compounds is slightly higher than after treatment at 2mbar (see Table 1).

### Example 3: Effect of Temperature

Another RBD palm olein IV 56 was treated as the oil in Example 1 with 0.123 ml 4 M aqueous NaOH, corresponding to 14 ppm OH⁻, at different temperatures for 2 hours.

TABLE 3
Effect of temperature during heat treatment with aqueous
base on selected oil constituents.

| | Before | After heat treatment | | |
|---|---|---|---|---|
| Temperature | heat treatment | 200° C. | 225° C. | 245° C. |
| [3-MCPD] | 3.7 ppm | 0.7 ppm | 0.6 ppm | 1.5 ppm |
| [2-MCPD] | | | | |
| Degree of interesterification | — | 10% | 55% | 90% |
| Glycidol | 7.7 ppm | 3.4 ppm | 5.3 ppm | 19 ppm |

In this case the content of 3-MCPD- and glycidyl esters was analyzed according to DGF C-VI 18 and reported as equivalents of free 3-MCPD and glycidol respectively.

The results in Table 3 show that at higher temperatures interesterification takes place to a higher degree and at temperature above 225° C. the reduction of 3-MCPD becomes less effective. It can also be seen from Table 3 that the concentration of glycidol-compounds increases at higher temperatures.

### Example 4: Effect of High FFA Content in the Starting Material

Example 1 was repeated with the same oil and the same addition of NaOH, but at the same time the oil was added 1% free fatty acids (oleic acid).

TABLE 4
Effect of adding FFA before heat treatment on selected oil constituents.

| | Before heat | |
|---|---|---|
| | treatment | After heat treatment |
| [3-MCPD] | 3.3 ppm | 0.6 ppm |
| [2-MCPD] | 1.6 ppm | 0.4 ppm |
| FFA* | 1.1% | 0.03% |
| Degree of | — | 5% |
| interesterification | | |
| Glycidol | 8.4 ppm | 1.5 ppm |

*Reported as oleic acid (molar mass of 282 g/mol)

Analysis for FFA was performed using IUPAC 2.201. It can be seen from Table 4 that the degree of interesterification is less that in Example 1 and, at the same time, the content of glycidol compounds is reduced more than in Example 1.

### Example 5: Effect of Glycerol Added

Example 1 was repeated with the same oil and a lower content of NaOH (0.055 ml 4 M aqueous solution, corresponding to 7 ppm OH⁻), but at the same time the oil was added 0.3% glycerol to increase reaction speed with the lower level of alkali catalyst.

TABLE 5
Effect of adding glycerol before heat treatment on selected oil constituents.

| | Before heat treatment | After heat treatment |
|---|---|---|
| [3-MCPD] | 3.3 ppm | 0.5 ppm |
| [2-MCPD] | 1.6 ppm | 0.4 ppm |
| Degree of | — | 20% |
| interesterification | | |
| Glycidol | 8.4 ppm | 3.3 ppm |

It can be seen from Table 5 that, when compared to Example 1, the addition of glycerol and the lower base concentration reduces the degree of interesterification, while the content of MCPD compounds are still reduced significantly.

### Example 6: Effect of Treating Time

Example 1 was repeated with the same oil and the same addition of NaOH, but with different processing time.

TABLE 6
Effect of treating time on selected oil constituents.

| | Before heat | After heat treatment | | |
|---|---|---|---|---|
| Time | treatment | 30 min | 60 min | 120 min |
| [3-MCPD] | 3.3 ppm | 1.1 ppm | 0.9 ppm | 0.7 ppm |
| [2-MCPD] | 1.6 ppm | 1.0 ppm | 0.7 ppm | 0.4 ppm |
| Degree of | — | 5% | 20% | 45% |
| interesterification | | | | |
| Glycidol | 8.4 ppm | 2.8 ppm | 4.6 ppm | 5.3 ppm |

It can be seen from Table 6, that with an increase of treating time, a better reduction of MCDP-compounds is achieved, while the degree of interesterification goes up with treating time and the reduction of glycidol compounds is less for longer treating times. The entry in Table 6 for 120 minutes is taken from Table 1 for easy comparison.

### Example 7: Effect of Alkali Content

The experiment from Example 3 was repeated with a lower content of alkali, only 0.075 ml of a 4 M aqueous solution of NaOH was added, corresponding to 9 ppm OFT, at different temperatures.

TABLE 7
Effect of base-concentration on selected oil constituents.

| | Before | After heat treatment | | |
|---|---|---|---|---|
| Temperature | heat treatment | 175° C. | 200° C. | 240° C. |
| [3-MCPD] | 3.7 ppm | 1.8 ppm | 0.8 ppm | 1.1 ppm |
| [2-MCPD] | | | | |
| Degree of interesterification | — | 10% | 5% | 55% |
| Glycidol | 7.7 ppm | 4.0 ppm | 2.2 ppm | 5.1 ppm |

When comparing to example 3 this shows that when the addition of alkali is reduced a higher temperature may be applied. And even at 175° C. and this low content of alkali the content of 3-MCPD is reduced by 50% and the degree of interesterification is negligible.

### Example 8: Effect of Higher Base Concentration at Different Temperatures

The experiment from Example 1 was repeated at different temperatures using a higher addition of alkali, 0.246 ml of a 4 M aqueous solution of NaOH, corresponding to 28 ppm OH⁻, was added.

TABLE 8
Effect of base concentration and temperature on selected oil constituents.

| | |
|---|---|
| Before | After heat treatment |

| Temperature | heat treatment | 210° C. | 235° C. |
|---|---|---|---|
| [3-MCPD] | 3.3 ppm | 0.5 ppm | 1.2 pm |
| [2-MCPD] | 1.6 ppm | 0.5 ppm | 0.5 ppm |
| Degree of | — | 30% | 100% |
| interesterification | | | |
| Glycidol | 8.4 ppm | 7.3 ppm | 18 ppm |

The results in Table 8 show, when compared to Example 1 that higher concentrations of base lead to more interesterification and less glycidyl ester reduction. At higher temperatures, the amount of glycidol compounds is significantly increased.

### Example 9: Effect of Further Processing—Bleaching and Deodorising

The experiment from Example 1 was repeated at 210° C. for 120 minutes with 0.074 ml of a 4 M aqueous solution of NaOH added, corresponding to 9 ppm OH⁻.

After the heat treatment the oil was bleached at 90° C. for 30 minutes at a pressure of 30-40 mbar using 0.5 % Tonsil Supreme 118 FF neutralised bleaching earth, pH in water suspension 6-8. The oil was subsequently deodorized at 210° C. using 2% stripping stream and a pressure of 2 mbar during 120 minutes.

TABLE 9
Effect of bleaching and deodorization after alkaline heat treatment with
aqueous base and steam at 210° C. and 2 mbar on selected oil constituents.

| | After heat | After | After |
|---|---|---|---|
| | treatmet | bleaching | deodorization |
| [3-MCPD] | 0.6 ppm | 0.6 ppm | 0.8 ppm |
| [2-MCPD] | 0.5 ppm | 0.5 ppm | 0.4 ppm |
| Degree of | 20% | not analyzed | 20% |
| interesterification | | | |
| Glycidol | 3.7 | 2.7 ppm | 0.2 ppm |

The results in Table 9 indicate that neither bleaching nor deodorization under the specified conditions increases the content of MCPD compounds significantly.

### Example 10: Heat Treatment of Refined Sunflower Oil

The experiment of Example 1 was repeated with refined sunflower oil which was mixed with 0.1 ml 4 M aqueous KOH, corresponding to 11 ppm OH⁻. The blend was heated to 215° C. for 120 minutes in a glass laboratory deodorizer at a reduced pressure of about 2 mbar. About 2 weight % steam was used as stirring and stripping agent.

TABLE 10
Effect of heat treatment with aqueous base and steam at 215° C.
and 2 mbar on selected oil constituents.

| | Before heat treatment | After heat treatment |
|---|---|---|
| [3-MCPD] | 0.83 ppm | 0.12 ppm |
| [2-MCPD] | 0.39 ppm | 0.10 ppm |
| Degree of | — | 20% |
| interesterification | | |
| Glycidol | 0.10 ppm | 3.6 ppm |

For liquid oil like sunflower oil the SFC is not suitable for determining the degree of interesterification. Instead the fatty acid composition in the sn-2 position of the triglyceride according to IUPAC 2.210 was used to calculate the degree of interesterification. The starting oil was defined as 0% interesterified. 100% interesterification was defined as to correspond to a sn-2 fatty acid composition being equal to the total fatty acid composition (measured with IUPAC 2.304). For sunflower oil oleic and linoleic acid are the major fatty acids (>10%) and an average of their degree of interesterification was used as the degree of interesterification of the sample.

The results given in Table 10 show an overall MCPD-compound reduction of almost 82%.

### Example 11: Bleaching and Deodorization of Heat Treated Refined Sunflower Oil

The heat treated oil of Example 10 was bleached at 90° C. for 30 minutes at a pressure of 3-40 mbar using 1.0 % Tonsil Supreme 118 FF neutralised bleaching earth, pH in water suspension 6-8. 600 g of the oil was subsequently deodorized at 215° C. using 2% stripping stream and a pressure of 2 mbar during 120 minutes.

TABLE 11
Effect of bleaching and deodorization after alkaline heat treatment with
aqueous base and steam at 215° C. and 2 mbar on selected oil constituents

| | After bleaching | After deodorization |
|---|---|---|
| [3-MCPD] | 0.11 ppm | 0.18 ppm |
| [2-MCPD] | 0.10. ppm | <0.10 ppm |
| Degree of interesterification | Not analysed | 20% |
| Glycidol | 0.21 ppm | <0.10 ppm |

The results in Table 11 indicate that neither bleaching nor deodorization under the specified conditions increases the content of MCPD compounds significantly

### Example 12: Other Means of Refining the Heat Treated Oil

The oil treated at 225° C. from Example 3 was further refined by bleaching with an acid activate bleaching earth (1 % Tonsil Optimum 215 FF, pH in a water suspension 2.3-3.5) and added citric acid. The same oil was bleached according to an alternative process with a neutralized bleaching earth (1 % Tonsil Supreme 118 FF, pH in a water suspension 6-8) without the addition of citric acid.

TABLE 12
Effect of bleaching with different bleaching earth after heat treatment.

| | After heat | After bleaching with | After bleaching with |
|---|---|---|---|
| | treatment | acid bleaching earth. | neutralised bleaching earth. |
| [3-MCPD] | 0.6 ppm | 2.2 ppm | 0.5 ppm |
| [2-MCPD] | | | |
| Glycidol | 5.3 ppm | 0.1 ppm | 0.2 ppm |

Table 12 shows that after a bleaching process with acid activated bleaching earth and citric acid a major part of the 3-MCPD is recovered, whereas the low content of 3-MCPD is maintained when using a neutral bleaching earth and no acid treatment.

### Example 13: Effect of Adding FFA During Heat Treatment

Example 4 was repeated with another batch of RBD palm olein IV 56 and treated at 235° C. with repeated additions of 1.0 % free fatty acids (oleic) by weight of the original amount of RBD palm olein IV 56 oil every 24 minutes (in total five additions: 0, 24, 48, 72 and 96)

TABLE 13
Effect of adding longer chain FFA during heat
treatment on selected oil constituents.

| | Before heat | After heat |
|---|---|---|
| | treatment | treatment |
| [3-MCPD] | 4.9 ppm | 0.4 ppm |
| [2-MCPD] | 2.2 ppm | 0.3 ppm |
| FFA* | 1.0% | 0.04% |
| Degree of | — | 15% |
| interesterification | | |
| Glycidol | 8.5 ppm | 1.8 ppm |

*Reported as oleic acid (molar mass of 282 g/mol)

It can be seen from Table 13 that addition of free fatty acids (here oleic) during the heat treatment is a way to avoid FFA depletion and maintain a low degree of interesterification even at a higher temperature while still having significant MCPD reduction.

### Example 14: Effect of Adding Longer Chain FFA

Example 4 was repeated with RBD palm olein IV 56 and another source of free fatty acids, namely 0.3% by weight of the original amount of RBD palm olein IV 56 oil of behenic acid.

TABLE 14
Effect of adding longer chain FFA during heat treatment
on selected oil constituents.

| | Before heat | After heat |
|---|---|---|
| | treatment | treatment |
| [3-MCPD] | 3.9 ppm | 0.9 ppm |
| [2-MCPD] | 2.4 ppm | 0.7 ppm |
| FFA* | 0.35% | 0.05% |
| Degree of | — | 5% |
| interesterification | | |
| Glycidol | 9.6 ppm | 1.17 ppm |

*Reported as behenic acid (molar mass of 341 g/mol)

It can be seen from Table 14 that results are similar to Example 4 even though much less, however longer, fatty acid is added.

1. A process for lowering the amount of esters of 2-chloro-1,2-propanediol and 3-chloro-1,2-propanediol in a refined triglyceride oil, wherein the oil prior to entering the process has been treated with at least one refining step; and
wherein the oil comprises triglycerides of fatty acids comprising a carbon chain length of C12-C24 in an amount of at least 50% of the total triglyceride content,
and wherein the process comprises the steps of:
blending the oil with a base; and
heat treating the oil while passing steam through the oil at reduced pressure,
keeping the degree of interesterification in the product from the process below 60%.

2. The process according to claim 1, wherein the degree of interesterification in the oil is 50% or less.

3. The process according to claim 1, wherein the heat treatment step is performed at a temperature between 120° C. and 240° C.

4. The process according to claim 1, wherein the heat treatment step has a duration between 10 minutes and 4 hours.

5. The process according to claim 1, wherein the reduced pressure is between 1 and 100 mbar.

6. The process according to claim 1, wherein the process further comprises contacting the oil with neutral bleaching earth after the heat treatment step.

7. The process according to claim 6, wherein the bleaching earth is chosen from bleaching clays based on minerals or bleaching earth with a pH in hydrous suspension between 4 and 9.

8. The process according to claim 7, wherein the clays based on minerals are chosen from the bentonit, fuller earth, or sepiolite.

9. The process according to claim 6 wherein the concentration of glycidyl esters in the triglyceride oil is reduced by at least 80 when compared to the concentration of glycidyl esters in the triglyceride oil after the heat treatment step, comprising contacting the oil with a) neutral bleaching earth, or b) neutral bleaching earth followed by a deodorization.

10. The process according to claim 1, wherein the at least one refining step is chosen from de-gumming, washing, drying, neutralizing, bleaching, carbon treatment, filtering, distillation, or deodorisation.

11. The process according to claim 1, wherein free fatty acids are added to the oil.

12. The process according to claim 1, wherein free fatty acids are added to the oil prior to the heat treatment step, or during the heat treatment step.

13. The process according to claim 11, wherein the free fatty acids are added in an amount ranging from 0.1 to 3% by weight of the amount of oil.

14. The process according to claim 1, wherein glycerol is added to the oil prior to the heat treatment step.

15. The process according to claim 14, wherein the glycerol is added in an amount ranging from 0.1 to 1% by weight of the amount of oil.

16. The process according to claim 1, any wherein the oil comprises triglycerides of fatty acids comprising a carbon chain length of C12-C24 in an amount of at least 60% of the total triglyceride content.

17. The process according to claim 1, wherein the triglyceride oil is obtained from palm oil, sunflower oil, rape seed oil, soy bean oil, corn oil, coconut oil, palm kernel oil, shea kernel oil, structured triglycerides manufactured by positional specific lipases, their fractions, or combinations thereof.

18. The process according to claim 1, wherein the base is chosen from NaOH, KOH, other hydroxides of alkali metals, or hydroxides of alkaline earth metals.

19. The process according to claim 1, wherein the base is an aqueous solution, a solid, saponified fatty acids, saponified triglyceride oil or any combination thereof.

20. The process according to claim 1, wherein the concentration of base blended into the oil ranges from 2 ppm to 30 ppm hydroxide ion.

21. The process according to claim 1, wherein the concentration of esters of 2-chloro-1,2-propanediol and 3-chloro-1-propanediol in refined triglyceride oil is reduced by at least 50% relative to the initial concentration.

22. The process according to claim 1, wherein the triglyceride oil comprises a native triglyceride structure.

23. The process according to claim 1, wherein the process further comprises adding the heat-treated triglyceride oil to a food product.

24-25. (canceled)

26. The process according to claim 1, wherein the degree of interesterification in the oil is 10% or less.

27. The process according to claim 1, wherein the heat treatment step is performed at a temperature between 200° C. and 225° C.

28. The process according to claim 1, wherein the heat treatment step has a duration between 30 minutes and 2 hours.

29. The process according to claim 1, wherein the reduced pressure is between 2 and 10 mbar.

30. The process according to claim 6, wherein the bleaching earth is chosen from bleaching clays based on minerals or bleaching earth with a pH in hydrous suspension between 6-8.

31. The process according to claim 1 wherein the concentration of base blended into the oil ranges from 5 ppm to 12 ppm hydroxide ion.

32. The process according to claim 1, wherein the concentration of esters of 2-chloro-1,2-propanediol and 3-chloro-1,2-propanediol in refined triglyceride oil is reduced by at least 80% relative to the initial concentration.

33. The process according to claim 1, wherein free fatty acids are added to the oil prior to the heat treatment step, and during the heat treatment step.
